(19) United States
(12) Patent Application Publication
(10) Pub. No.: US 2024/0033156 A1
(43) Pub. Date: Feb. 1, 2024

(54) DEVICE AND METHOD FOR KNEE SURGERY THERAPY

(71) Applicants: Lawrence Guillen, Farmington, NM (US); Charles Brusseau, Tijeras, NM (US)

(72) Inventors: Lawrence Guillen, Farmington, NM (US); Charles Brusseau, Tijeras, NM (US)

(21) Appl. No.: 18/227,673

(22) Filed: Jul. 28, 2023

Related U.S. Application Data
(60) Provisional application No. 63/393,877, filed on Jul. 30, 2022.

(51) Int. Cl. A61H 1/00

(52) U.S. Cl. CPC A61H 1/005; A61H 2205/102

(57) ABSTRACT

The present invention is a device and method for post-knee surgery therapy. A resting platform accommodates a patient in the seated position and is attached to an actuator assembly that allows the patient to extend their leg on the assembly. The actuator assembly connection is adjustable laterally and longitudinally. A foot pedal assembly is attached to a worm drive in the actuator assembly which, when activated, moves the patient's foot closer to or away from their hips causing knee flexion and extension. The therapy can be accomplished using an electronic device with preset measurements and durations.

### CROSS-REFERENCE TO RELATED APPLICATIONS

This application claims priority to and the benefit of the filing of U.S. Provisional patent application Ser. No. 63/393,877, filed on Jul. 30, 2022, entitled “Device and Method For Knee Surgery Therapy” and the specification thereof is incorporated here by reference.

### BACKGROUND OF THE INVENTION

The present invention relates to a therapy device and method for patients recovering from knee surgery to enable a full range of motion using gentle knee flexion and extension.

U.S. Patent Application No. 2014/0094721 to Diallo discloses a device for increasing the range of motion of a patient's knee joint, including a longitudinal track frame that has a sitting platform on one end and a movable leg and foot platform on the other.

U.S. Pat. No. 10,420,691 to Stewart discloses a motorized device providing for both flexion and extension of the knee.

U.S. Patent Application No. 2017/0100296 to Method discloses a method for gathering information related to the use of a continuous passive motion device by receiving, storing, and displaying information from a device processing unit.

European Patent Application No. EP 2583656 discloses a knee rehabilitation device comprising a foot assist that can be attached to the leg and a motion device which moves the assist in a given direction.

Finally, U.S. Pat. No. 9,205,015 is to Guillen, who is one of the present inventors. That prior art invention does not include many of the improvements claimed herein.

Among other things, none of the prior art discloses resting platform adjustment guides to properly align a patient's hips and leg. Nor does the prior art disclose an adjustable hip stabilizer belt to prevent a patient's hips from moving or straps around the forefoot, ankle, and lower calf to brace the foot in the foot pedal. Importantly, none of the prior art discloses the automated method comprising a continuous passive motion process for extension of the knee using an electronic device with preset measurements and durations.

### BRIEF SUMMARY OF THE INVENTION

The present invention provides for significant improvements for patients recovering from knee surgery and needing to perform knee flexion and extension exercises to enable or regain a full range of motion. The knee surgery therapy device claimed herein consists of a resting platform attached to an actuator assembly having a longitudinal assembly axis. The resting platform has a seat and a back to accommodate a patient in the upright seated position. The therapy device also includes an adjustable hip stabilizer belt which can be removably attached to the resting platform. The actuator assembly contains a motor-driven worm drive positioned axially in the actuator assembly that is attached to a foot pedal assembly. When the worm drive is rotated in either direction, the foot pedal assembly moves toward or away from the resting platform causing knee extension and flexion.

The means for connecting the resting platform to the actuator assembly includes an actuator assembly adjustment bar that is positioned laterally upon the distal end of the seat of the resting platform. There is a channel located on the proximal end of the actuator assembly that is slidably engageable with the actuator assembly adjustment bar such that the actuator assembly is movable along the actuator adjustment bar to any position on either side of the longitudinal platform axis. This can accommodate a patient's right leg or left leg and the relative location of the knee with respect to the patient's torso. Also, the actuator assembly adjustment bar has actuator assembly adjustment indicia on or adjacent to the actuator assembly adjustment bar such that the position on either side of the longitudinal platform axis is indicated. The indicia can be easily displayed by making the adjustment bar incorporate a standard ruler (or any instrument used to make length measurements) so one can easily see the preferred location of the actuator assembly relative to the resting platform and the patient.

Additionally, the means for connecting the resting platform to the actuator assembly can include two alignment guides located on either side of the seat of the resting platform which can be extended and retracted so that the actuator assembly can be moved longitudinally to accommodate the patient's leg length. Further, one or more knobs can be installed on the side of the seat atop the alignment guides so that the actuator assembly can be temporarily locked in place.

The foot pedal assembly comprises a foot pedal and a foot pedal cradle, where the patient's foot is placed in the foot pedal and the foot pedal rests in the foot pedal cradle. In the preferred embodiment, the foot pedal has a flange-like protrusion on either side of it. The foot pedal cradle is u-shaped and has two notches in the tops of the “U.” The shafts of the flange-like protrusions on the foot pedal fit in the u-shaped notches of the cradle. In this way the patient can move their foot by flexing and extending their ankle but the foot cannot move up and down or side to side. One or more straps can also be used to secure the patient's foot. In the preferred embodiment, there are three straps attached to the foot pedal that encircle the forefoot, ankle, and lower calf of the patient. Ideally, the foot pedal is configured such that the patient's ankle remains at or near a 90° angle. If the patient desires to interrupt the therapy using the present invention, they can easily lift their foot and foot pedal out of the foot cradle.

The foot pedal cradle attaches to the worm drive so that when the worm drive is rotated, the foot moves with it causing extension or flexion of the patient's knee. In the preferred embodiment of this invention, there is a bracket attached and located underneath and perpendicular to the foot pedal cradle. The bracket attaches via screws to a horizontal plate that has a protruding vertical piece that fits into the bracket. This horizontal plate assembly can be seen at the top of FIG. 15. Connected to the bottom of the horizontal plate is a standard acme or trapezoidal nut block. The nut block is sized based on the worm drive screw shaft diameter and the pitch of the worm drive screw threads. Eight millimeters is the preferred size of the shaft and nut block in this embodiment. When the worm drive rotates, it causes the nut block to move with it. When the nut block moves, it takes the foot pedal cradle with it thereby moving the patient's foot, which is located in the foot pedal resting in the foot pedal cradle. When the foot pedal assembly is closest to the patient, their knee is bent causing flexion and when the foot pedal assembly is farthest from the patient the knee is straightened causing extension.

The present invention also includes a preferred method of employing the device for knee surgery therapy using gentle, patient-directed, knee extension repetitions. The method comprises the steps of obtaining the resting platform having a seat and a back to accommodate the patient in the seated upright position. The resting platform is connected to the actuator assembly that has a longitudinal assembly axis. Inside the actuator assembly, there are two cams positioned laterally across from each other. There are also two thigh straps, each having a base end and a free end. The base ends attach to the bottom of the actuator assembly beneath each cam such that the thigh straps are windable and unwindable around the cams.

The patient then sits on the resting platform with their leg extended on the longitudinal assembly axis of the actuator assembly. The free ends of the thighs straps connect to each other on top of the patient's thigh to create a thigh strap loop that encircles the patient's thigh. In the preferred embodiment, the free ends of the thigh straps are connected to each other using a hook and loop, Velcro® type attachment mechanism.

A continuous passive motion process can then be initiated by activating at least one cam motor to drivably rotate the cams in opposite directions, thereby winding the thigh straps. This shortens the length of the thigh strap loop moving the thigh in a downward direction and causing an extension of knee.

This knee extension therapy using the thigh straps and cam rotations can be initiated and controlled using an electronic device. In the preferred embodiment, the electronic device is a handheld tablet, such as an iPad®, that is wirelessly connected to the cam motors to control the rotation and counter-rotation of the motors. The electronic device can be pre-programmed with a measurement selected from the group consisting of a length of the patient's femur, a length of the patient's tibia, starting degrees of flexion of the non-effected leg, starting degrees of extension of the non-afflicted leg, the circumference of the hip stabilizer belt, the preferred indicia on the actuator assembly adjustment bar, and the preferred extension length of the alignment guides located on either side of the seat.

In the preferred embodiment for a means for rotating and counter-rotating the motor-driven worm drive, the electronic device sends a signal to a control board and printed circuit board assembly, which sends another signal to an actuator motor causing the motor to rotate in one direction or the other. The rotating actuator motor activates a pulley system that causes the worm drive to rotate creating axial movement that causes the foot pedal assembly to also move axially. The pulley system is comprised of a motor pulley and a worm-drive pulley connected by a belt. When the actuator motor rotates, it causes the motor pulley to rotate in the same direction which, through the corresponding movement of the belt, causes the worm-drive pulley to also rotate in the same direction, thus causing the worm drive shaft to rotate.

In the preferred embodiment of the cam and cam motor assembly, the cam assembly is attached to the actuator assembly. A thigh strap that has a base end and a free end, the base end attaching to the actuator assembly beneath the cam such that the thigh strap is windable and unwindable around the cam. When activated, a cam motor drivably rotates and counter-rotates the cam thereby winding or unwinding the thigh strap.

In the preferred embodiment, the actuator assembly is an aluminum box that is 32 inches long, 10 inches wide, and 2 inches deep, with a removable cover. The resting platform is made of a two-piece, hinged and braced aluminum assembly that is 28 inches long, 20 inches wide, and 2 inches deep and upholstered in medical-grade vinyl. The back of the resting platform can be raised from 0 to 55 degrees with an adjustment knob located on the upper edge of the back. The hip stabilizer belt is a 4-inch wide medical-grade vinyl belt which has a peg that is 2⅜ inches long, 4½ inches wide, and ⅝ of an inch deep. The peg is enclosed in a pouch which is sewn onto the back of the belt and inserted/retracted into one of six slots in the resting platform to hold the client's hips stationary. The foot pedal can be lifted free of the foot pedal cradle by the patient as a safety measure, if needed.

Also in the preferred embodiment, when the patient is using the thigh straps for knee extension therapy, the thigh strap loop is shortened so that the knee is lowered % of an inch for 5 to 10 seconds as tolerated by the patient. There is then a 1 to 10 second pause. The pause is followed by the release of thigh strap pressure to return the patient's knee to the start position. This is repeated as necessary and as tolerated by the patient.

As used herein, certain terms have the following definitions:

A “cam” is a rotating or sliding piece, such as a cylinder with an irregular shape, in a mechanical linkage used to transform rotary motion into linear motion or vice versa.

A “worm drive” is a mechanical arrangement consisting of a revolving screw shaft (worm) of a given diameter bearing screw threads of a given pitch. When the screw shaft (worm) is rotated, axial movement is imparted to the screw threads.

“Knee flexion” is a movement that decreases the angle between a patient's thigh and shin, like curling their heel to their glutes.

“Knee extension” is a movement that increases the angle between a patient's thigh and their shin, like making their leg straight.

Examples of an “electronic device” include, but are not limited to, pagers, laptops, cellular telephones, radios, compact disc and cassette players/recorders, portable digital assistants, audio devices, and watches with input capability, whether wired or wireless.

### BRIEF DESCRIPTION OF THE DRAWINGS

FIG. 1 is a top perspective view of the device for knee surgery therapy.

FIG. 2 is a top perspective view of the resting platform.

FIG. 3 is the bottom perspective view of the resting platform.

FIG. 4 is a top perspective view of the front of the adjustable hip stabilizer belt.

FIG. 5 is a top perspective view of the back of the adjustable hip stabilizer belt.

FIG. 6 is a top perspective view of the means for connecting the resting platform to the actuator assembly.

FIG. 7 is a top perspective view of the inside of the actuator assembly.

FIG. 8 is a top perspective view of the foot pedal assembly with the foot pedal resting in the foot pedal cradle.

FIG. 9 is a top perspective view of the foot pedal assembly with the foot pedal above the foot pedal cradle.

FIG. 10 is a top perspective view of the foot pedal assembly with the foot pedal above the foot pedal cradle also showing the preferred embodiment of three foot straps on the foot pedal.

FIG. 11 shows an example of a screen viewable on the electronic device during the continuous passive motion process.

FIG. 12 is a top perspective view of the device for knee surgery therapy configured for leg extension.

FIG. 13 is a top perspective view of the device for knee surgery therapy configured for leg flexion.

FIG. 14 is a top perspective view of the use of an electronic device to initiate the continuous passive motion process.

FIG. 15 is a top perspective view of the inside of the actuator assembly showing the preferred embodiment of a means for rotating and counter-rotating the motor-driven worm drive.

FIG. 16 shows a top perspective view of the preferred embodiment of the cam and cam motor assembly.

### DETAILED DESCRIPTION OF THE DRAWINGS

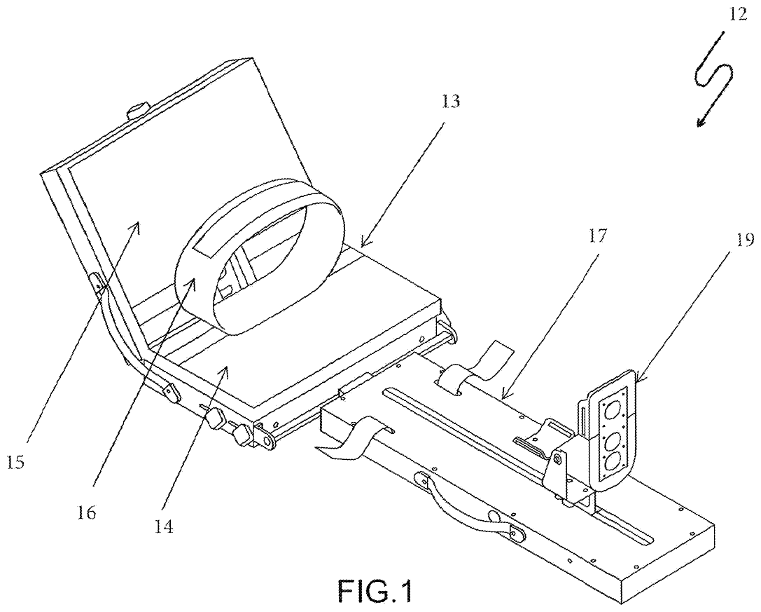

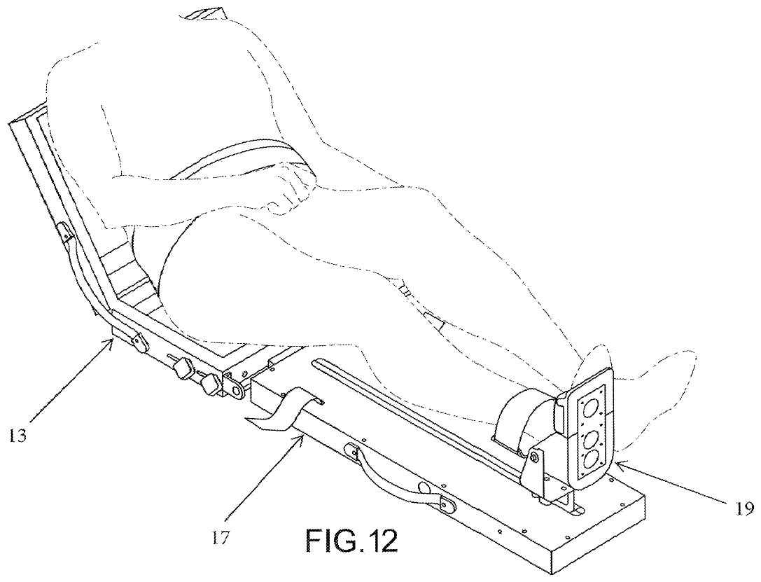

FIG. 1 shows the device for knee surgery therapy 12 comprising a resting platform 13 comprising a seat 14 and a back 15 to accommodate a patient (patient not shown, see FIGS. 12-14) in the upright seated position, the patient having a torso and at least one leg. The device further comprises a hip stabilizer belt 16 that encircles the patient's torso and can be removably attached to the resting platform 13, an actuator assembly 17 connected to the resting platform 13 having a longitudinal assembly axis, a motor-driven worm drive (worm drive not shown, see FIG. 7) positioned axially in the actuator assembly, a foot pedal assembly 19 connected to the worm drive and a means for rotating or counter-rotating the worm drive to impart axial movement to the worm drive thereby moving the foot pedal assembly 19 toward or away from the resting platform 13.

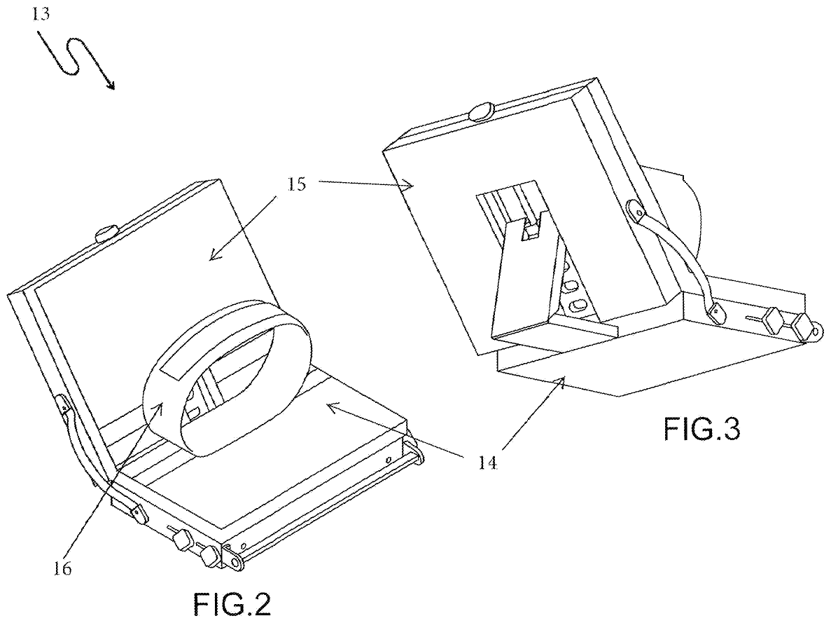

FIGS. 2 and 3 show the top and bottom of the resting platform 13, including the seat 14, the back 15, and the hip stabilizer belt 16.

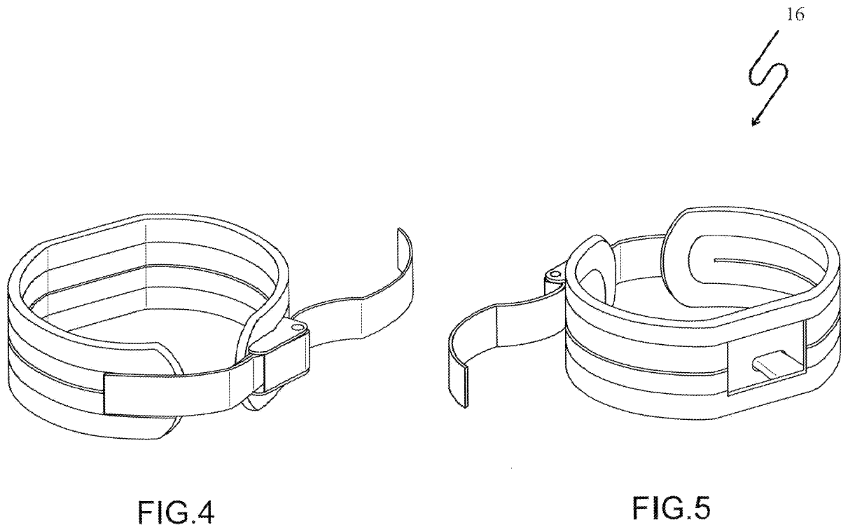

FIGS. 4 and 5 show two views of the hip stabilizer belt 16 that has an adjustable circumference to accommodate the patient's torso size.

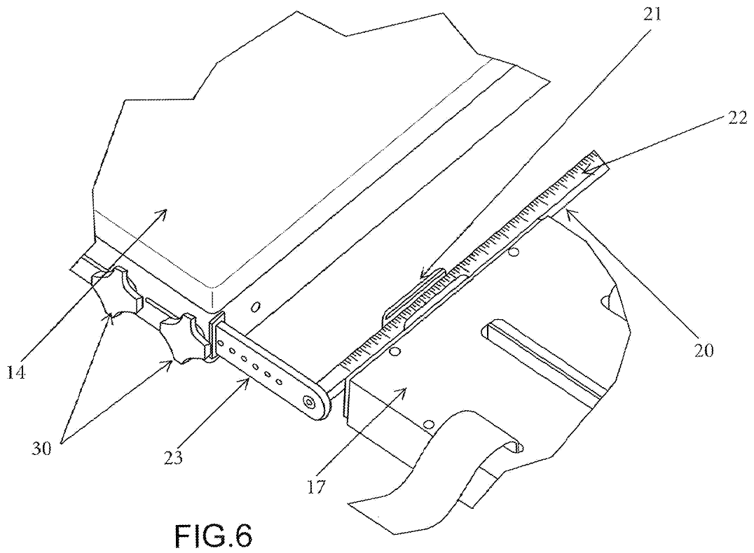

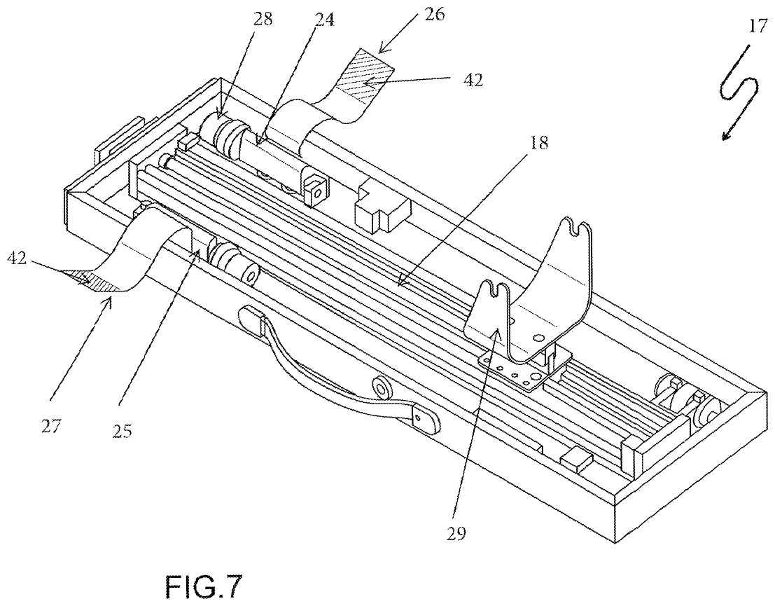

FIG. 6 shows the means for connecting the resting platform 13 (complete resting platform not shown, see FIGS. 2 and 3) to the actuator assembly 17, the means comprising an actuator assembly adjustment bar 20 positioned laterally upon a distal end of the seat 14 of the resting platform 13 and a channel 21 located on a proximal end of the actuator assembly 17 that is slidably engageable with the actuator assembly adjustment bar 20 such that the actuator assembly 17 is movable along the actuator adjustment bar 20 to any of a plurality of positions on either side of the longitudinal platform axis. The actuator assembly adjustment bar 20 has actuator assembly adjustment indicia 22 on or adjacent to the actuator assembly adjustment bar 20 such that one of the plurality of positions on either side of the longitudinal platform axis is indicated.

FIG. 6 also shows a means for connecting the resting platform 13 to the actuator assembly 17 such that the actuator assembly 17 is movably adjustable longitudinally in relation to the longitudinal platform axis. The means for connecting the resting platform 13 to the actuator assembly 17 also comprises one or more alignment guides 23 located on either side of the seat 14 of the resting platform 13 and attaching to the actuator assembly adjustment bar 22, a means for extending and retracting the alignment guides 23 such that the actuator assembly 17 can be variably positioned in relation to the seat 14 of the resting platform 13 to accommodate the patient's leg length, and a means 30 to temporarily lock the actuator assembly 17 in one of a plurality of distances from the seat of the resting platform 13.

FIG. 7 shows a first cam 24 attached to the actuator assembly 17 and a second cam 25 positioned laterally to the first cam 24 and attached to the actuator assembly 17, a first thigh strap 26 having a first base end and a first free end, the first base end attached to the actuator assembly 17 beneath the first cam 24 such that the first thigh strap 26 is windable and unwindable around the first cam 24. FIG. 7 also shows a second thigh strap 27 having a second base end and a second free end, the second base end attached to the actuator assembly 17 beneath the second cam 25 such that the second thigh strap 27 is windable and unwindable around the second cam 25. Also shown is a means 42 for releasably connecting the first free end of the first thigh strap 26 and the second free end of the second thigh strap 27 to create a thigh strap loop having an effective length, and at least one motor 28 for drivably rotating and counter-rotating the first cam 24 and the second cam 25 in opposite directions thereby to wind or unwind concurrently the first thigh strap 26 and the second thigh strap 27 on its respective cam, thereby varying the effective length of the thigh strap loop.

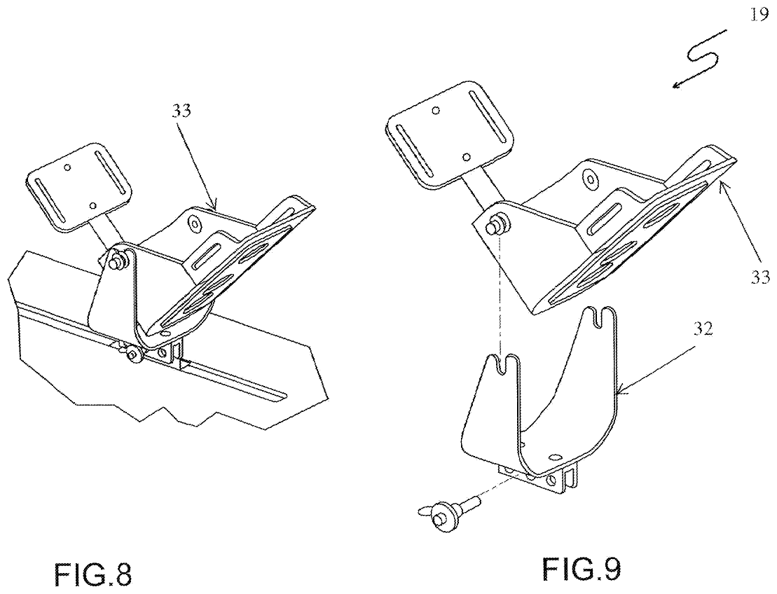

FIGS. 8 and 9 show the foot pedal assembly 19 comprising a foot pedal cradle 32 attached to the worm drive 18 (see FIG. 7), a foot pedal 33 that rests in and adjustably attaches to the foot cradle 32, a means for adjusting the position of the foot pedal 33 in the foot cradle 32, and one or more straps 35 that are attached to the foot pedal 33 and can adjustably secure a patient's foot to the foot pedal 33.

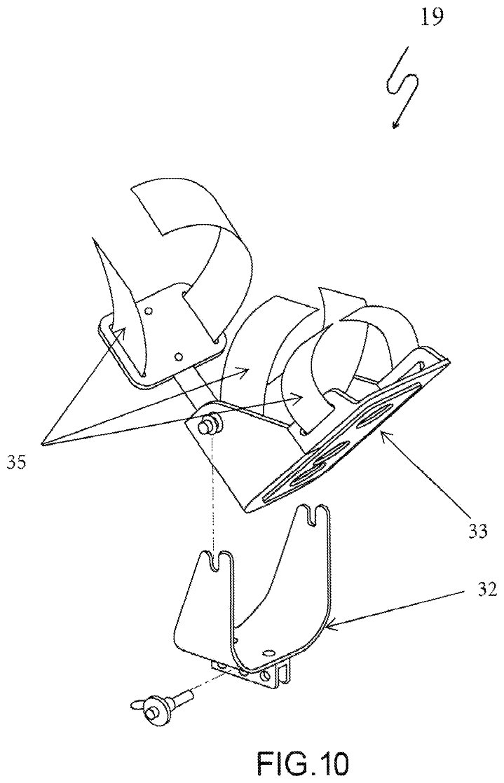

FIG. 10 shows the foot pedal assembly 19 comprising a foot pedal cradle 32, a foot pedal 33 that rests in and adjustably attaches to the foot cradle 32, and one or more straps 35 that are attached to the foot pedal 33 and can adjustably secure a patient's foot to the foot pedal 33. FIG. 10 shows the preferred embodiment of three straps around the forefoot, ankle, and lower calf to brace the patient's foot in the foot pedal.

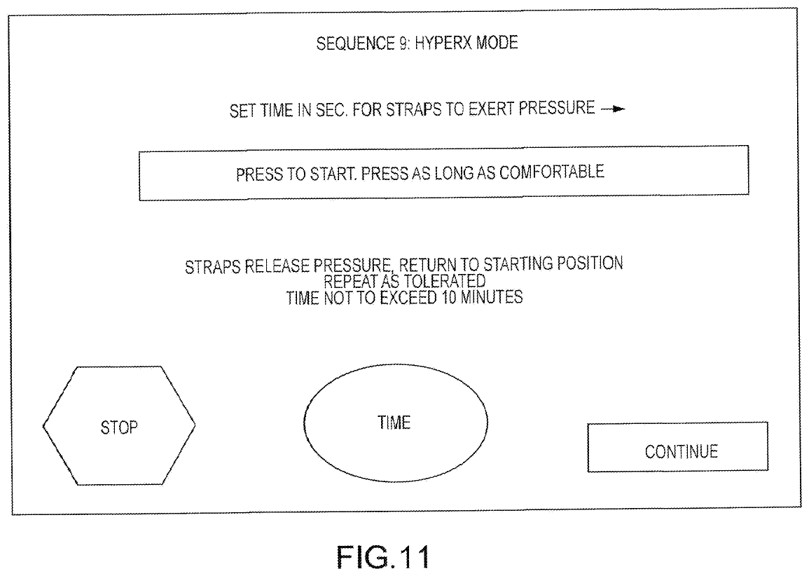

FIG. 11 shows an example of a screen viewable on the electronic device during the continuous passive motion process for extension of the patient's knee.

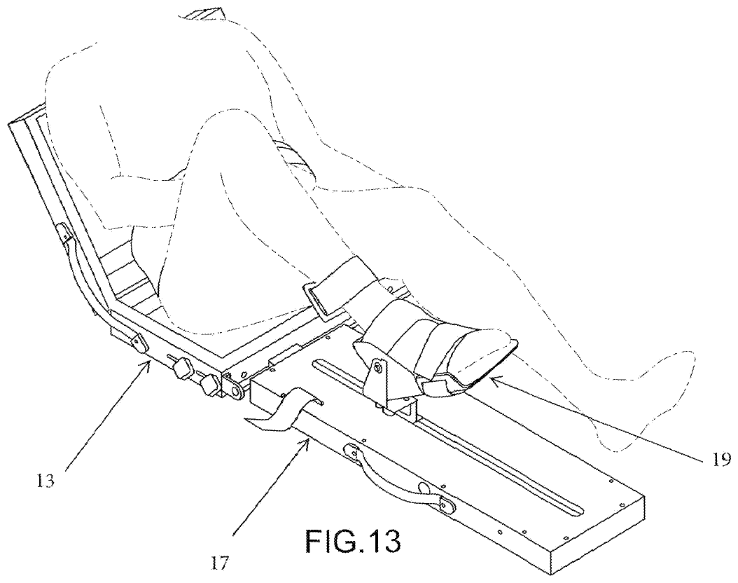

FIG. 12 shows the device for knee surgery therapy 12 where the foot pedal assembly 36 is positioned for the leg extension part of the therapy and FIG. 13 shows the foot pedal assembly 36 positioned for leg flexion part of the therapy.

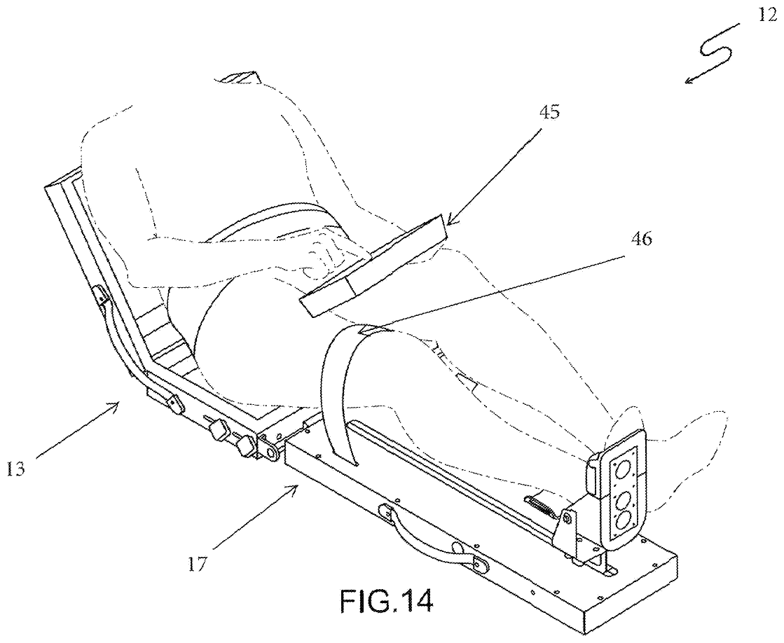

FIG. 14 shows the patient using a device for knee surgery therapy 12 sitting in an upright position on a resting platform 13 connected to an actuator assembly 17 having a longitudinal assembly axis to the resting platform 13, and the patient extending their leg on the longitudinal assembly axis of the actuator assembly 17. The first free end of the first thigh strap 26 is connected to the second free end of the second thigh strap 27 to create a thigh strap loop 46 having an effective length. A continuous passive motion process for extension of the patient's knee is initiated by activating at least one motor 28 to drivably rotate the first cam 24 and the second cam 25 in opposite directions, thereby winding concurrently the first thigh strap 26 and the second thigh strap 27 on its respective cam, thereby shortening the effective length of the thigh strap loop 46 and causing an extension of knee.

FIG. 14 also shows the use of an electronic device 45 to initiate the continuous passive motion process described in the previous paragraph. The electronic device can be pre-programmed with a measurement selected from the group consisting of a length of the patient's femur, a length of the patient's tibia, starting degrees of flexion of a non-effected leg, starting degrees of extension of the non-afflicted leg, the circumference of the hip stabilizer belt, the preferred indicia on the actuator assembly adjustment bar, and the preferred extension length of the alignment guides located on either side of the seat.

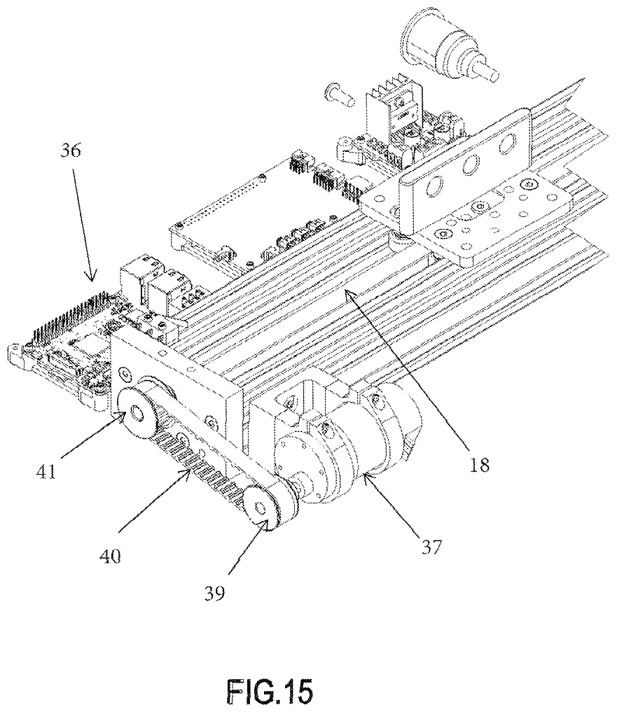

FIG. 15 shows the preferred embodiment of a means for rotating and counter-rotating the motor-driven worm drive 18 to impart axial movement to the motor-driven worm drive 18 thereby moving the foot pedal assembly 19 toward or away from the resting platform 13. In this preferred embodiment, the electronic device 35 sends a signal to the control board and printed circuit board assembly 36 which sends another signal to the actuator motor 37 causing it to rotate in one direction or the other. The rotating actuator motor 37 activates a pulley system that causes the worm drive 18 to rotate creating axial movement that causes the foot pedal assembly 19 to also move axially. The pulley system is comprised of a motor pulley 39 and a worm-drive pulley 41 connected by a belt 40. When the actuator motor 37 rotates, it causes the motor pulley 39 to rotate in the same direction which, through the corresponding movement of the belt 40, causes the worm-drive pulley 41 to also rotate in the same direction, thus causing the worm drive shaft to rotate.

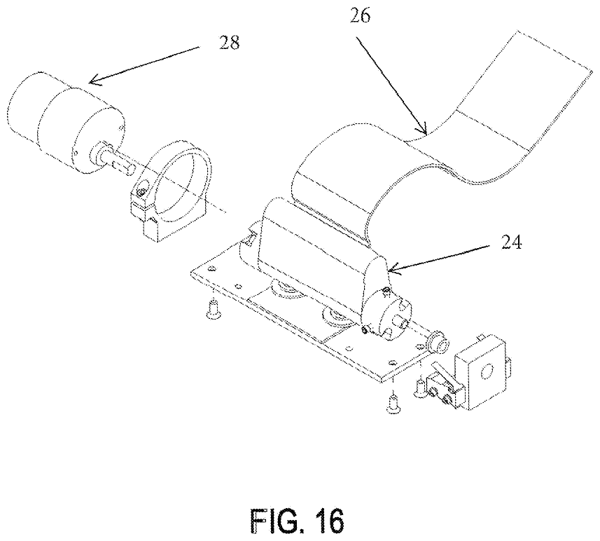

FIG. 16 shows the preferred embodiment of the cam and cam motor assembly. There, a first cam 24 is attached to the actuator assembly. A first thigh strap 26 having a first base end and a first free end, the first base end attached to the actuator assembly beneath the first cam 24 such that the first thigh strap 26 is windable and unwindable around the first cam 24. When activated, a motor 28 drivably rotates and counter-rotates the first cam 24 thereby winding or unwinding the first thigh strap 26.

Whereas the FIGURES and description have illustrated and described the concept and preferred embodiment of the present invention, it should be apparent to those skilled in the art that various changes may be made in the form of the invention without affecting the scope thereof. The detailed description above is not intended in any way to limit the broad features or principles of the invention, or the scope of patent monopoly to be granted.

We claim:

1. A device for knee surgery therapy comprising:
a. a resting platform comprising a seat and a back to accommodate a patient in the upright seated position, the patient having a torso and at least one leg;
b. a hip stabilizer belt that encircles the patient's torso and can be removably attached to the resting platform;
c. an actuator assembly connected to the resting platform having a longitudinal assembly axis;
d. a motor-driven worm drive positioned axially in the actuator assembly;
e. a foot pedal assembly connected to the motor-driven worm drive; and
f. a means for rotating and counter-rotating the motor-driven worm drive to impart axial movement to the motor-driven worm drive thereby moving the foot pedal assembly toward or away from the resting platform.

2. The device of claim 1 wherein the hip stabilizer belt has an adjustable circumference to accommodate the patient's torso size.

3. The device of claim 1 further comprising a means for connecting the resting platform to the actuator assembly such that the actuator assembly is movably adjustable laterally in relation to the longitudinal assembly axis.

4. The device of claim 1 wherein the means for connecting the resting platform to the actuator assembly comprises:
a. the means for connecting the resting platform to the actuator assembly is such that the actuator assembly is movably adjustable laterally in relation to the longitudinal assembly axis;
b. the means for connecting the resting platform to the actuator assembly further comprising an actuator assembly adjustment bar positioned laterally upon a distal end of the seat of the resting platform; and
c. a channel located on a proximal end of the actuator assembly that is slidably engageable with the actuator assembly adjustment bar such that the actuator assembly is movable along the actuator assembly adjustment bar to any of a plurality of positions on either side of the longitudinal assembly axis.

5. The device of claim 1 further comprising:
a. a means for connecting the resting platform to the actuator assembly is such that the actuator assembly is movably adjustable laterally in relation to the longitudinal assembly axis;
b. said means for connecting the resting platform to the actuator assembly further comprising an actuator assembly adjustment bar positioned laterally upon a distal end of the seat of the resting platform;
c. a channel located on a proximal end of the actuator assembly that is slidably engageable with the actuator assembly adjustment bar such that the actuator assembly is movable along the actuator assembly adjustment bar to any of a plurality of positions on either side of the longitudinal assembly axis; and
d. actuator assembly adjustment bar indicia on or adjacent to the actuator assembly adjustment bar such that one of the plurality of positions on either side of the longitudinal assembly axis is indicated.

6. The device of claim 1 further comprising a means for connecting the resting platform to the actuator assembly such that the actuator assembly is movably adjustable longitudinally in relation to the longitudinal assembly axis.

7. The device of claim 1 further comprising:
a. a means for connecting the resting platform to the actuator assembly is such that the actuator assembly is movably adjustable longitudinally in relation to the longitudinal assembly axis;
b. one or more alignment guides located on either side of the seat of the resting platform and attaching to the actuator assembly adjustment bar; and
c. a means for extending and retracting the one or more alignment guides such that the actuator assembly can be variably positioned in relation to the seat of the resting platform to accommodate the patient's leg length.

8. The device of claim 1 further comprising:
a. a means for connecting the resting platform to the actuator assembly such that the actuator assembly is movably adjustable longitudinally in relation to the longitudinal assembly axis; and
b. a means to temporarily lock the actuator assembly in one of a plurality of distances from the seat of the resting platform.

9. The device of claim 1 further comprising:
a. a first cam attached to the actuator assembly and a second cam positioned laterally to the first cam and attached to the actuator assembly;
b. a first thigh strap having a first base end and a first free end, the first base end attached to the actuator assembly beneath the first cam such that the first thigh strap is windable and unwindable around the first cam;
c. a second thigh strap having a second base end and a second free end, the second base end attached to the actuator assembly beneath the second cam such that the second thigh strap is windable and unwindable around the second cam;
d. a means for releasably connecting the first free end of the first thigh strap and the second free end of the second thigh strap to create a thigh strap loop having an effective length; and
e. at least one motor for drivably rotating and counter-rotating the first cam and the second cam in opposite directions thereby to wind or unwind concurrently the first thigh strap and the second thigh strap on its respective cam, thereby varying the effective length of the thigh strap loop.

10. The device of claim 1 wherein the foot pedal assembly comprises:
a. a foot petal cradle attached to the motor-driven worm drive;
b. a foot pedal that rests in and adjustably attaches to the foot cradle;
c. a means for adjusting the position of the foot pedal in the foot cradle; and
d. one or more straps that are attached to the foot pedal and can adjustably secure a patient's foot to the foot pedal.

11. A method of using a device for knee surgery therapy comprising the steps of:
a. obtaining a resting platform comprising a seat and a back to accommodate a patient in the seated upright position;
b. connecting an actuator assembly having a longitudinal assembly axis to the resting platform;
c. attaching a first cam to the actuator assembly;
d. attaching a second cam to the actuator assembly such that the second cam is positioned laterally to the first cam;
e. obtaining a first thigh strap having a first base end and a first free end and attaching the first base end to the actuator frame beneath the first cam such that the first thigh strap is windable and unwindable around the first cam;
f. obtaining a second thigh strap having a second base end and a second free end and attaching the second base end to the actuator frame beneath the second cam such that the second thigh strap is windable and unwindable around the second cam;
g. seating a patient, said patient having a leg and a knee, on the resting platform and extending the patient's leg on the longitudinal assembly axis of the actuator assembly;
h. connecting the first free end of the first thigh strap to the second free end of the second thigh strap to create a thigh strap loop having an effective length; and
i. initiating a continuous passive motion process for extension of the patient's knee by activating at least one motor to drivably rotate the first cam and the second cam in opposite directions, thereby winding concurrently the first thigh strap and the second thigh strap on its respective cam, thereby shortening the effective length of the thigh strap loop and causing an extension of knee.

12. A method of using a device for knee surgery therapy comprising the steps of:
a. obtaining a resting platform comprising a seat and a back to accommodate a patient in the seated upright position;
b. connecting an actuator assembly having a longitudinal assembly axis to the resting platform;
c. attaching a first cam to the actuator assembly;
d. attaching a second cam to the actuator assembly such that the second cam is positioned laterally to the first cam;
e. obtaining a first thigh strap having a first base end and a first free end and attaching the first base end to the actuator frame beneath the first cam such that the first thigh strap is windable and unwindable around the first cam;
f. obtaining a second thigh strap having a second base end and a second free end and attaching the second base end to the actuator frame beneath the second cam such that the second thigh strap is windable and unwindable around the second cam;
g. seating a patient, said patient having a leg and a knee, on the resting platform and extending the patient's leg on the longitudinal assembly axis of the actuator assembly;
h. connecting the first free end of the first thigh strap to the second free end of the second thigh strap to create a thigh strap loop having an effective length;
i. initiating a continuous passive motion process for extension of the patient's knee by activating at least one motor to drivably rotate the first cam and the second cam in opposite directions, thereby winding concurrently the first thigh strap and the second thigh strap on its respective cam, thereby shortening the effective length of the thigh strap loop and causing an extension of knee;
j. using an electronic device to initiate the continuous passive motion process for extension of the patient's knee by activating at least one motor to drivably rotate the first cam and the second cam in opposite directions, thereby winding concurrently the first thigh strap and the second thigh strap on its respective cam, thereby shortening the effective length of the thigh strap loop and causing an extension of knee; and
k. pre-programming the electronic device with a measurement selected from the group consisting of a length of the patient's femur, a length of the patient's tibia, starting degrees of flexion of a non-effected leg, starting degrees of extension of the non-afflicted leg, the circumference of the hip stabilizer belt, the preferred indicia on the actuator assembly adjustment bar, and the preferred extension length of the one or more alignment guides located on either side of the seat.
